(19) United States
(12) Patent Application Publication
(10) Pub. No.: US 2026/0037161 A1
(43) Pub. Date: Feb. 5, 2026

(54) ADJUSTING POWER CONSUMPTION OF ONGOING OPERATIONS ON A SOLID STATE DEVICE

(71) Applicant: Microchip Technology Incorporated, Chandler, AZ (US)

(72) Inventors: Pitamber SHUKLA, San Jose, CA (US); Nian Niles YANG, Mountain View, CA (US); Srinivas YELISETTI, Fremont, CA (US)

(21) Appl. No.: 18/977,463

(22) Filed: Dec. 11, 2024

Related U.S. Application Data
(60) Provisional application No. 63/679,055, filed on Aug. 2, 2024.

(51) Int. Cl. G06F 3/06

(52) U.S. Cl. CPC G06F 3/0625; G06F 3/0653; G06F 3/0679

(57) ABSTRACT

In some implementations, a controller may determine a power consumption, of a storage device, for ongoing operations on the storage device. The controller may determine that an available power, for the storage device, is insufficient for performing an incoming operation based on the power consumption. The controller may adjust the power consumption based on determining that the available power is insufficient for performing the incoming operation. The controller may perform the incoming operation based on adjusting the power consumption for the ongoing operations.

### CROSS-REFERENCE TO RELATED APPLICATION

This Patent Application claims priority to Provisional Patent Application No. 63/679,055, filed on Aug. 2, 2024, and entitled “ADJUSTING POWER CONSUMPTION OF ONGOING OPERATIONS ON A SOLID STATE DEVICE.” The disclosure of the prior Application is considered part of and is incorporated by reference into this Patent Application.

### FIELD

The present disclosure generally relates to power consumption of non-volatile memory devices and, for example, to power consumption management of non-volatile memory devices.

### BACKGROUND

A non-volatile memory device may include a memory device that may store and retain data without external power supply. One example of a non-volatile memory device is a NAND flash memory device. A solid-state drive (SSD) may include a controller and a plurality of non-volatile memory devices. The non-volatile memory devices may store data that is accessible via the controller. The controller may control operations performed on the SSD. The operations may include read operations, write operations, and erase operations.

### SUMMARY

A storage device may comprise: a controller to: detect a request to perform an incoming operation on the storage device, wherein the incoming operation is associated with a quality of service (QOS) target of the storage device; determine a power consumption, of the storage device, for ongoing operations across multiple channels of the storage device; determine that an available power, for the storage device, is insufficient for performing the incoming operation based on the power consumption; adjust the power consumption based on determining that the available power is insufficient for performing the incoming operation; and perform the incoming operation based on adjusting the power consumption for the ongoing operations.

A method may comprising: determining a power consumption, of a storage device, for ongoing operations on the storage device; determining that an available power, for the storage device, is insufficient for performing an incoming operation based on the power consumption; adjusting the power consumption based on determining that the available power is insufficient for performing the incoming operation; and performing the incoming operation based on adjusting the power consumption for the ongoing operations.

A non-transitory computer-readable medium storing a set of instructions, the set of instructions may comprise: one or more instructions that, when executed by one or more processors of a controller, cause the controller to: determine a power consumption, of a storage device, for ongoing operations on the storage device; determine that an available power, for the storage device, is insufficient for performing an incoming operation based on the power consumption; adjust the power consumption based on determining that the available power is insufficient for performing the incoming operation; and perform the incoming operation based on adjusting the power consumption for the ongoing operations.

### BRIEF DESCRIPTION OF THE DRAWINGS

FIG. 1 is a diagram of an example implementation described herein.

FIGS. 2A and 2B are flowcharts of an example process associated with adjusting power consumption of ongoing operations performed on an SSD.

FIG. 3 is a flowchart of an example process associated with adjusting power consumption of ongoing operations performed on an SSD.

### DETAILED DESCRIPTION

The following detailed description of example implementations refers to the accompanying drawings. The same reference numbers in different drawings may identify the same or similar elements.

A controller of a solid state drive (SSD) may control operations performed on non-volatile memory devices of the SSD. The operations may include read operations, write operations, and erase operations. Performing the operations consumes power.

Currently, power consumption of an SSD is managed using an existing power token based power management technique. The power token based management technique may be used to determine if power is to be available for an incoming operation while an ongoing operation is consuming the power until the ongoing operation is completed. The term “incoming operation” may be used to refer to an operation that has been requested but has not been initiated. The term “ongoing operation” may be used to refer to an operation that is being performed. If the ongoing operation consumes power such that power allocated to the SSD is completely utilized, the incoming operation may be prevented from being performed until the ongoing operation is completed.

Currently, the power token based management technique does not account for whether performing the incoming operation is related to performance or quality of service (QOS) of the SSD. Accordingly, the power token based management technique may prevent the incoming operation (related to performance or QoS) from being performed until the ongoing operation is completed. Preventing the incoming operation may result in performance and QoS issues for the SSD. Accordingly, the power token based management technique may present a technical problem with respect to incoming operations related to performance or QoS.

With respect to QoS, some approaches may attempt to speed up operations of numerous components of the SSD (e.g., application-specific integrated circuit (ASIC), non-volatile memory devices, static random-access memory (SRAM), double data rate (DDR), without limitation) to improve the QoS. However, such approaches are expensive, difficult, and limited to scale while the power consumption may be uncertain, because the QoS requirements will be more stringent.

Further with respect to QoS, for state of the art SSD, the QoS is to be within a given limit. For example, 99% (called 2 nines) of reads must be completed within 100 us; or 99.999% (called 5 nines) must be within 1 ms. With existing solutions for power management, if the performance of an incoming host operation is critical to QoS and if ongoing operations are consuming a significant amount of power, then the system firmware (FW) (e.g., a controller of the SSD) will wait until some of the power of the SSD is freed up after the completion of some of the ongoing operations. In this regard, existing solutions may lead to poor performance and QoS issues for the SSD.

Implementations described herein provide a technical solution to the technical problem discussed above regarding QoS issues caused by existing power management solutions of an SSD. For example, implementations described herein are directed to adjusting power consumption of ongoing operations on the SSD to allocate sufficient power for execution of an incoming operation on the SSD. The incoming operation may include an operation that is to be performed for the purposes of satisfying a QoS target of the SSD.

In some implementations, a controller (e.g., firmware) of the SSD may adjust the power consumption, to achieve the QoS target, by adjusting a power supply to the SSD, adjusting latencies of the ongoing operations, staggering operations across different channels, or a combination of the foregoing. In other words, implementations described herein may adaptively adjust a power supply, slow down the ongoing operations, and introduce offsets in operations running across different flash channels of the SSD to improve the QoS for high priority host operations. Referring back to the power supply, in a NAND gate, Vcc refers to the supply voltage. The ongoing operations may include an erase operation, a program operation, and a read operation.

In some examples, within a given power of the SSD, the controller (e.g., system firmware) will decide to adjust operational parameters, such as lower Vcc, adjust a speed of erase/program/read operations (e.g., in light of performance the SSD), and offset the ongoing operations across different channels to lower the power consumption of the SSD, thereby meeting QoS targets of the SSD.

Implementations (e.g., a power management solution) described herein provide several technical benefits. For example, the power management solution will significantly improve a QoS measure of the SSD. The power management solution (e.g., a firmware driven solution) will significantly improve the QoS of the SSD without affecting the reliability of the SSD. The power management solution may also be very effective in running as a background activity of the controller (e.g., as a garbage collection operation) with reduced system power usage.

The power management solution may reduce the power usage of the SSD to incorporate any outstanding host request to improve QoS of the drive. The power management solution may reduce the overall SSD drive power usage during the system FW background operation. The power management solution will significantly improve the QoS in hyperscale SSDs, which are used in data center storage system.

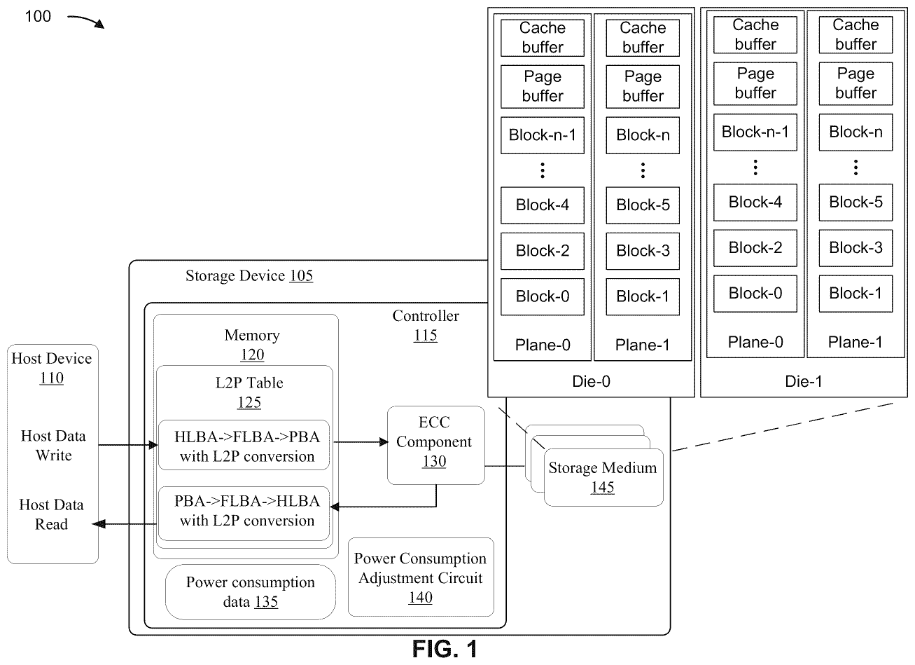

FIG. 1 is a diagram of an example implementation 100 described herein. Example implementation 100 describes components and operations associated with a storage device 105. In some implementations, storage device 105 may include a solid state drive (SSD). As shown in FIG. 1, storage device 105 may be associated with a host device 110. Host device 110 may write data (also referred to as “host data”) to storage device 105 and/or read data from storage device 105. For example, as shown in FIG. 1, host device 110 may initiate a host data write operation (e.g., a write operation) to write the host data to storage device 105 (e.g., to store the data on storage device 105) and may initiate a host read operation (e.g., a read operation) to read the host data from storage device 105.

Host device 110 may include one or more devices capable of receiving, generating, storing, processing, and/or providing information associated with generating a logical to physical (L2P) data structure (or L2P table), as described elsewhere herein. The host device 110 may include a communication device and a computing device. For example, the host device 110 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

As shown in FIG. 1, storage device 105 may include a controller 115. Controller 115 may include one or more of an application specific integrated circuit (ASIC) or firmware. Controller 115 may cause functions to be performed on storage device 105, such as read operations, write operations, erase operations, and garbage collection operations, among other examples. Controller 115 may include a memory 120 and an error correction code (ECC) component 130. Memory 120 may include a RAM (e.g., dynamic random access memory (DRAM), and a synchronous DRAM (SDRAM), among other examples).

As shown in FIG. 1, memory 120 may include an L2P table 125 (or an L2P data structure). L2P table 125 may store a mapping between host logical block addresses (or logical addresses identified by host device 110) and physical block addresses (or physical addresses of non-volatile memory devices of storage device 105). In some implementations, L2P table 125 may be generated by controller 115.

In some implementations, controller 115 may identify a host logical block address (HLBA) associated with the host data by which host device 110 may reference the host data in a future read operation. As shown in FIG. 1, controller 115 may convert the HLBA to a flash logical block address (FLBA) or other local logical block address, and then may link the FLBA to a physical block address (PBA) using an L2P conversion. Conversely, controller 115 may convert a PBA to an FLBA or other local logical block address, and then may link the FLBA to an HLBA using a physical to logical (P2L) conversion. In this way, the host device 110 may send a static address associated with the host data, controller 115 may link the address known to host device 110 to an address known to storage device 105 (the FLBA), and controller 115 may link the address known to storage device 105 to a physical address of the host data within a storage medium of storage device 105.

Controller 115 may store the links between the HLBA, the FLBA, and the PBA in L2P table 125. In some aspects, the host data may be moved within the storage medium or between storage mediums of storage device 105, which controller 115 may note in the link between the FLBA and the physical location. In this way, the HLBA may bypass being updated when the host data is moved to a new PBA.

ECC component 130 may include an ECC engine. ECC component 130 may perform error correction code encoding on the host data. In some implementations, the error correction code encoding may include adding redundancy, parity bits, or other information that can later be used to identify errors in the host data when read from the storage medium. Controller 115 may provide the host data, after encoding, via flash control channels (not shown) to write on storage mediums of storage device 105. In some implementations, ECC component 130 may perform decoding on data obtained from storage device 105.

As shown in FIG. 1, controller 115 may include power consumption data 135. Power consumption data 135 may be stored in a memory of controller 115, such as memory 120, another memory, or a combination of the foregoing. In some implementations, power consumption data 135 may be stored in a memory external to controller 115. Power consumption data 135 may include information regarding power consumption by different operations performed by different components of storage device 105. In some implementations, power consumption data 135 may include information regarding an amount of power consumed by different operations (e.g., erase operations, read operations, write operations, and garbage collection operations, without limitation).

In some implementations, power consumption data 135 may include information regarding an amount of power consumed by different portions of an operation (e.g., a beginning of the operation, and an ending of the operation, without limitation). In some implementations, power consumption data 135 may include information regarding an amount of power consumed by different dies (e.g., 128 dies), an amount of power consumed by power consumption by one or more DRAMs, and an amount of power consumed by power consumption by one or more static RAMs, without limitation. In some implementations, power consumption data 135 may be used to determine an amount of power consumed by an operation. In some examples, the amount of power may be determined based on information identifying the operation. Alternatively, the amount of power may be determined based on a die on which the operation is to be performed.

As shown in FIG. 1, controller 115 may include a priority based power consumption adjustment circuit 140 (also referred to as “power adjustment circuit 140” or a “power management circuit”). Power adjustment circuit 140 may adjust power consumed by storage device 105 as described herein. For example, as described herein, power adjustment circuit 140 may adjust the power consumption, to achieve the QoS target, by adjusting a power supply (e.g., the power supply for the NAND flash memory), adjusting latencies of the ongoing operations, staggering operations across different channels, or a combination of the foregoing). In other words, power management circuit 140 may adaptively adjust a power supply, slow down the ongoing operations, and introduce offsets in operations running across different flash channels of the SSD to improve the QoS for high priority host operations. The ongoing operations may be initiated by host device 110. Additionally, or alternatively, the ongoing operations may include maintenance tasks performed on storage device 105.

As shown in FIG. 1, storage device 105 may include storage mediums 145 (individually “storage medium 145” and collectively “storage mediums 145”). A storage medium 145 may include a non-volatile memory device. For example, the storage medium 145 may include a NAND memory device. In some situations, storage mediums 145 may be organized by data pools. A “data pool” may be used to refer to part of a storage medium 145 that stores a given type of data (e.g., single-layer cell (SLC) data, multi-layer cell (MLC) data, and triple-layer cell (TLC) data, without limitation).

As shown in FIG. 1, a storage medium 145 may include multiple dies. In some implementations, a die may include multiple planes. A plane may include multiple memory blocks (also referred to as “block”), one or more page buffers (associated with the blocks), and one or more cache buffers.

As indicated above, FIG. 1 is provided as an example. Other examples may differ from what is described with regard to FIG. 1. The number and arrangement of devices shown in FIG. 1 is provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

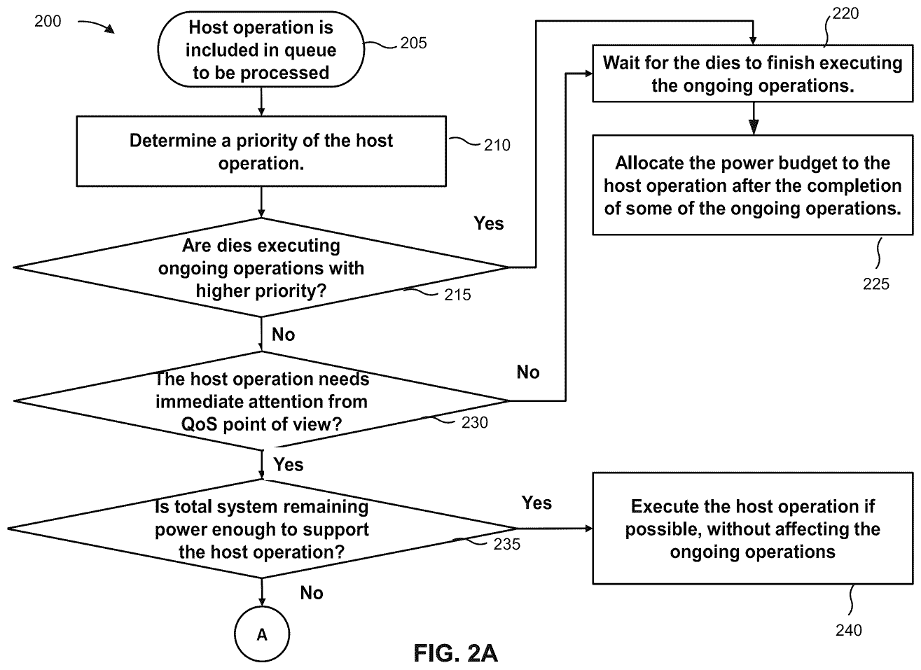

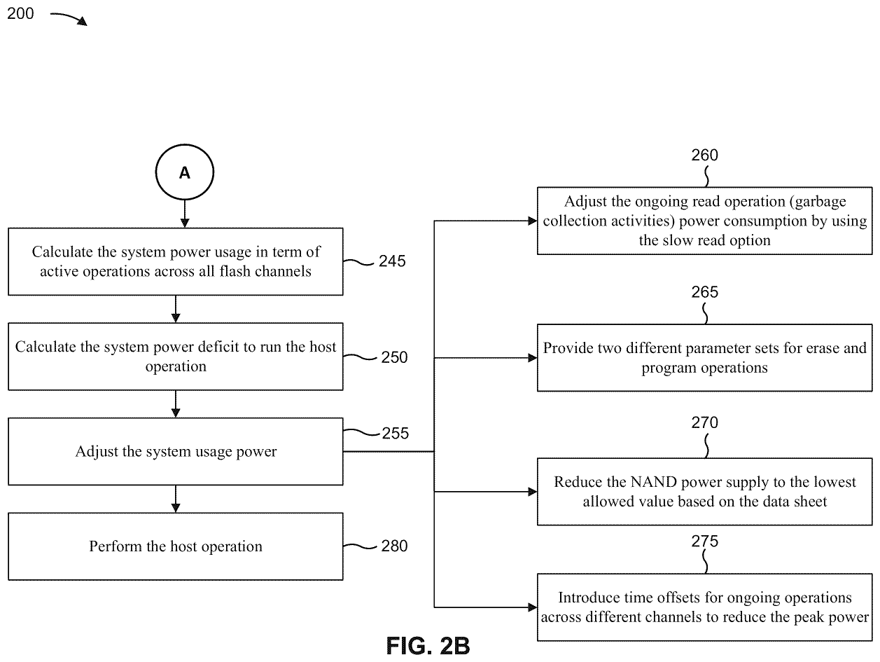

FIGS. 2A and 2B are flowcharts of an example process 200 associated with power consumption management based on priorities of incoming operations. In some implementations, one or more process blocks of FIGS. 2A and 2B may be performed by a controller (e.g., by controller 115 using power adjustment circuit 140).

As shown in FIG. 2A, process 200 may include a host operation being included in a queue to be processed (block 205). In some situations, the host operation may be issued. The “host operation” may refer to an operation initiated by host device 110. For example, controller 115 may detect that host device 110 has issued a command to perform an operation. As explained herein, the host operation may be an incoming operation.

As an example, the host operation may include a write operation to store (on storage device 105) data obtained by host device 110 (e.g., to store a picture captured by host device 110). As another example, the host operation may include a read operation to retrieve (from storage device 105) data obtained by host device 110 (e.g., to retrieve a picture captured by host device 110 and stored on storage device 105). The data may be stored on or retrieved from a die of storage device 105. For example, the die may be included on storage medium 145 of storage device 105. The die may be identified by the command. For example, the command (to perform the host operation) may include information identifying the die on which the host operation is to be performed.

As shown in FIG. 2A, process 200 may include determining a priority of the host operation (block 210). In some implementations, controller 115 may determine a priority associated with the host operation. In some implementations, the command may include information identifying the priority of the host operation. In some implementations, priorities of read operations and write operations (e.g., initiated by host device 110) may exceed priorities of other operations performed on storage device 105. The other operations may include telemetry operations to collect internal logs of storage device 105 and status read operations. In some implementations, the internal logs may provide information failures experienced by storage device 105. The information may be used to identify a root cause of failures, such as firmware issues, hardware failures, integrity errors, storage media errors, or temperature issues, among other examples. A priority of a read operation (e.g., initiated by host device 110) typically exceeds a priority of a write operation (e.g., initiated by host device 110).

As shown in FIG. 2A, process 200 may include determining whether dies are executing ongoing operations with higher priority (block 215). In some implementations, controller 115 may determine other priorities of ongoing operations being performed on storage device 105 and may determine whether the other priorities exceed the priority of the host operation. In some examples, controller 115 may determine whether the ongoing operations are initiated by host device 110 or whether the ongoing operations are initiated by a component of storage device 105, such controller 115. The ongoing operations are initiated by the component may include internal maintenance task. If the ongoing operations are initiated by a component of storage device 105, then the priority of the host operation may exceeds priorities of the ongoing operations. Alternatively, if the ongoing operations are initiated by host device 110, controller 115 may determine whether the ongoing operations are read operations or write operations. As explained herein, a read operation (e.g., initiated by host device 110) typically exceeds a priority of a write operation (e.g., initiated by host device 110). The ongoing operations may be operations being performed on other dies of storage device 105, such as a die of another storage medium 145, or another die of a same storage medium 145.

As shown in FIG. 2A, process 200 may include waiting for the dies to finish executing the ongoing operations (block 220). Controller 115 may determine whether the other priorities (of the ongoing operations) exceed the priority of the host operation. If the other priorities exceed the priority of the host operation, controller 115 may wait for the ongoing operations to be completed prior to performing the host operation. For example, controller 115 may determine that the ongoing operations are read operations initiated by host device 110.

As shown in FIG. 2A, process 200 may include allocating the power budget to the host operation after the completion of some of the ongoing operations (block 225). For example, after the ongoing operations are completed, controller 115 may allocate (or reserve) the power (released after the ongoing operations have been completed) for execution of the host operation. By allocating (or reserving) the power, controller 145 may ensure that other ongoing operations or other incoming operations do not utilize the power released.

As shown in FIG. 2A, process 200 may include determining whether the host operation needs immediate attention from a QoS point of view (block 230). For example, after determining that the other priorities (of the ongoing operations) do not exceed the priority of the host operation, controller 115 may determine whether the host operation is to proceed immediately. In some examples, the command may include information indicating whether the host operation is to be performed immediately. If the information indicates that the host operation is not to be performed immediately, controller 115 may wait for the ongoing operations to be completed prior to performing the host operation (as explained herein in connection with block 220).

As shown in FIG. 2A, process 200 may include determining that a total system remaining power is not enough to support the host operation (block 235). For example, controller 115 may determine that the host operation is to be performed immediately (e.g., determine that the host operation needs immediate attention from QoS point of view) and, accordingly, may determine a total remaining power for the SSD is not sufficient to support the host operation.

This decision can be made based on known average and peak power for dies under various operations such as erase, program, and read. In some examples, the average and peak power for the dies may be determined based on monitoring (over a period time) the various operations as they being performed on the dies. In some examples, the average and peak power may be predefined. In some implementations, firmware of storage device 105 (e.g., controller 115) may maintain a look up table that stores the average and peak power for each operation. In some example, the average and peak power may be a function of program erase cycles and/or temperature characteristics of storage device 105. In some situations, controller 115 may determine that the total amount of remaining power exceeds an amount of power to be consumed by the host operation. Based on determining that the total amount of remaining power exceeds the amount of power to be consumed by the host operation, controller 115 may cause the host operation to be performed. Because the total amount of remaining power exceeds the amount of power to be consumed by the host operation, performing the host operation may not affect ongoing operations on storage device 105. In some examples, controller 115 may wait for the release of some power budget with the completion of ongoing operations.

In some situations, controller 115 may determine that the total amount of remaining power does not exceed the amount of power to be consumed by the host operation. Accordingly, controller 115 may determine that the total system remaining power is not sufficient to support the host operation. In this regard, the power usage of the ongoing operations may be adjusted, as described below.

As shown in FIG. 2B, process 200 may include calculating the system power usage in term of active operations across all flash channels (block 245). For example, based on determining that the total system remaining power is not sufficient to support the host operation, controller 115 may calculate power usage by ongoing operations across all flash channels. For example, controller 115 may determine an amount of power being consumed by the ongoing operations. The ongoing operations may consume different amounts of power. The ongoing operations may include a program operation, a read operation, and an erase operation, without limitation. In some situations, the amount of power consumed by the ongoing operations may be pre-determined (e.g., at time of manufacture of storage device 105). Accordingly, based on identifying the ongoing operations, controller 115 may determine a total power consumption of storage device 105 as a result of the ongoing operation being performed.

As shown in FIG. 2B, process 200 may include calculating the system power deficit to run the host operation (block 250). The system power deficit may be calculated in term of active NAND operations across all NAND flash channels. For example, controller 115 may calculate the power deficit based on the following formula:

Power Deficit=(Power needed to execute Op-A)−(Available system power by considering all ongoing tasks).

As shown in FIG. 2B, process 200 may include adjusting the system usage power (block 255). For example, the system usage power may be adjusted by adjusting one or more operations and related operational parameters (in various combination) to address the host operation request. In some aspects, for example, controller 115 may adjust the one or more ongoing operations to reduce the power consumption. The one or more ongoing operations may include one or more of an ongoing read operation, an ongoing write operation, an ongoing erase operation. In some implementations, controller 115 may adjust an ongoing operation by adjusting a speed at which the ongoing operation is performed, thereby adjusting an amount of power consumed by the ongoing operation (as described below in connection with block 260). For example, controller 115 may adjust an ongoing read operation by reducing a speed of the ongoing read operation, thereby reducing an amount of power consumed by the ongoing read operation. In some implementations, controller 115 may utilize different parameter sets for the ongoing operations to adjust an amount of power consumed by the ongoing operations (as described below in connection with block 265). For example, one parameter set may be directed to high performance and, accordingly, may cause the ongoing operations to consume an increased amount of power. Another parameter set may be directed to low performance and, accordingly, may cause the ongoing operations to consume a reduced amount of power. In some implementations, controller 115 may adjust a power supply to adjust an amount of power consumed by the ongoing operations (as described below in connection with block 270).

As shown in FIG. 2B, process 200 may include adjusting the ongoing read operation (garbage collection activities) power consumption by using the slow read option (block 260). To note, the ongoing read operation can operate in fast Vs slow read using FW driven prefix command.

As shown in FIG. 2B, process 200 may include providing two different parameter sets for erase and program operations (block 265). The two different parameter sets may be provided for (1) high performance with higher power consumption; and (2) low performance with lower power consumption. In some implementations, system FW (e.g., controller 11) can enable option (2) using some prefix commands when drive needs extra power budget to meet the QoS target.

As shown in FIG. 2B, process 200 may include reducing the NAND power supply (e.g., the flash Vcc) to the lowest allowed value based on the data sheet (block 270). In some implementations, the data sheet may include information identifying a Vcc operating range for storage device 105 (e.g., for storage medium 145). In other words, the data sheet may include information identifying a range of supply voltages. In some situations, storage device 105 may operate using a supply voltage that is approximately in a middle of the range of supply voltages. Accordingly, in the event the system power (e.g., the amount of power consumed by the ongoing operation) is to be reduced at any given point of time, a value of the Vcc may be reduced to a lowest value identified by the data sheet. For example, the value of the Vcc may be reduced to the lowest value of the range of supply voltages. For example, a lower Vcc may reduce the overall system usage power to incorporate (or perform) the host operation. The lower Vcc may be lower than the middle of the range of supply voltages. As shown in FIG. 2B, process 200 may include introducing time offsets for ongoing operations across different channels to reduce the peak power (block 275). The time offset may be introduced to avoid the power throttling due to overlap of power critical steps running across different channels. In some situations, multiple operations may be performed simultaneously on different flash channels and on different chip enable elements. Accordingly, the peak power for the system may increase significantly. In an effort to reduce the peak power, controller 115 may introduce some time offsets among the different operations across the flash channels and the chip enable elements. The time offsets may cause the different operations to be initiated at different times or to be performed at different times instead of being performed simultaneously. By causing the different operations to be initiated at different times or to be performed at different times, controller 115 may reduce the amount of power that would have been consumed by the different operations when they are performed simultaneously.

As shown in FIG. 2, process 200 may include performing the host operation (block 280). For example, in some implementations, the host operation may be performed as soon as the system power usage is reduced such that the power can incorporate the power consumption due to the host operation. In some implementations, process 200 may include performing the host operation without affecting an ongoing operation on the targeted die. For example, controller 115 may determine that the total amount of remaining power exceeds the amount of power to be consumed by the host operation. Based on determining that the total amount of remaining power exceeds the amount of power to be consumed by the host operation, controller 115 may cause the host operation to be performed. Because the total amount of remaining power exceeds the amount of power to be consumed by the host operation, performing the host operation may not affect ongoing operations on storage device 105.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

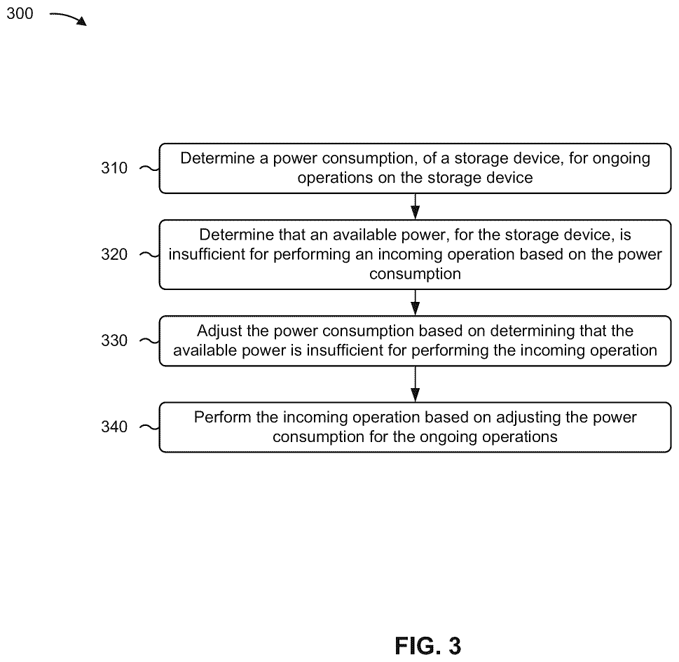

FIG. 3 is a flowchart of an example process 300 associated with power consumption management of a solid state device based on operation priority, as described herein. In some implementations, one or more process blocks of FIG. 3 may be performed by a storage device (e.g., storage device 105). In some implementations, one or more process blocks of FIG. 3 may be performed by another device or a group of devices separate from or including the storage device, such as a power management circuit (e.g., power adjustment circuit 140).

As shown in FIG. 3, process 300 may include determining a power consumption of a storage device, for ongoing operations on the storage device (block 310). For example, the controller may determine a power consumption of a storage device, for ongoing operations on the storage device, as described above.

As further shown in FIG. 3, process 300 may include determining that an available power, for the storage device, is insufficient for performing an incoming operation based on the power consumption (block 320). For example, the controller may determine that an available power, for the storage device, is insufficient for performing an incoming operation based on the power consumption, as described above.

As further shown in FIG. 3, process 300 may include adjusting the power consumption based on determining that the available power is insufficient for performing the incoming operation (block 330). For example, the controller may adjust the power consumption based on determining that the available power is insufficient for performing the incoming operation, as described above.

As further shown in FIG. 3, process 300 may include performing the incoming operation based on adjusting the power consumption for the ongoing operations (block 340). For example, the controller may perform the incoming operation based on adjusting the power consumption for the ongoing operations, as described above.

In some implementations, process 300 includes determining a power deficit associated with performing the incoming operation, and determining that the available power is insufficient for performing the incoming operation based on the power deficit.

In some implementations, process 300 includes determining that the available power is insufficient for performing the incoming operation after adjusting the power consumption, and continuing adjusting the power consumption based on determining that the available power is insufficient for performing the incoming operation after adjusting the power consumption.

In some implementations, adjusting the power consumption comprises one or more of introducing time offsets for the ongoing operations across the multiple channels, reducing a power supply to the storage device, enabling an option to reduce a performance of one or more of the ongoing operations to reduce a power consumption of the one or more ongoing operations, or reducing a speed of an ongoing read operation to reduce a power consumption of the ongoing read operation.

In some implementations, process 300 includes determining that the available power, for the storage device, is sufficient for performing the incoming operation after adjusting the power consumption, and performing the incoming operation based on determining that the available power is sufficient.

In some implementations, process 300 includes determining the incoming operation is associated with a QoS target of the storage device, and adjusting the power consumption to enable the incoming operation to be performed based on determining in the incoming operation.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

In some implementations, a storage device comprising: a controller to: detect a request to perform an incoming operation on the storage device, wherein the incoming operation is associated with a quality of service (QOS) target of the storage device; determine a power consumption, of the storage device, for ongoing operations across multiple channels of the storage device; determine that an available power, for the storage device, is insufficient for performing the incoming operation based on the power consumption; adjust the power consumption based on determining that the available power is insufficient for performing the incoming operation; and perform the incoming operation based on adjusting the power consumption for the ongoing operations.

In some implementations, a method comprising: determining a power consumption, of a storage device, for ongoing operations on the storage device; determining that an available power, for the storage device, is insufficient for performing an incoming operation based on the power consumption; adjusting the power consumption based on determining that the available power is insufficient for performing the incoming operation; and performing the incoming operation based on adjusting the power consumption for the ongoing operations.

In some implementations, a non-transitory computer-readable medium storing a set of instructions includes one or more instructions that, when executed by one or more processors of a controller, cause the controller to: determine a power consumption, of a storage device, for ongoing operations on the storage device; determine that an available power, for the storage device, is insufficient for performing an incoming operation based on the power consumption; adjust the power consumption based on determining that the available power is insufficient for performing the incoming operation; and perform the incoming operation based on adjusting the power consumption for the ongoing operations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly regarded in an illustrative rather than restrictive sense.

What is claimed is:

1. A storage device comprising:
a controller to:
detect a request to perform an incoming operation on the storage device,
wherein the incoming operation is associated with a quality of service (QoS) target of the storage device;
determine a power consumption, of the storage device, for ongoing operations across multiple channels of the storage device;
determine that an available power, for the storage device, is insufficient for performing the incoming operation based on the power consumption;
adjust the power consumption based on determining that the available power is insufficient for performing the incoming operation; and
perform the incoming operation based on adjusting the power consumption for the ongoing operations.

2. The storage device of claim 1, wherein the controller is to:
determine a power deficit associated with performing the incoming operation; and
determine that the available power is insufficient for performing the incoming operation based on the power deficit.

3. The storage device of claim 1, wherein the controller is to:
determine that the available power is insufficient for performing the incoming operation after adjusting the power consumption; and
continue adjusting the power consumption based on determining that the available power is insufficient for performing the incoming operation after adjusting the power consumption.

4. The storage device of claim 1, wherein, to adjust the power consumption, the controller is to:
reduce a speed of an ongoing read operation to reduce a power consumption of the ongoing read operation.

5. The storage device of claim 1, wherein, to adjust the power consumption, the controller is to:
enable an option to reduce a performance of one or more of the ongoing operations to reduce a power consumption of the one or more ongoing operations,
wherein the one or more of the ongoing operations include an erase operation or a program operation.

6. The storage device of claim 1, wherein, to adjust the power consumption, the controller is to:
reduce a power supply to the storage device.

7. The storage device of claim 1, wherein, to adjust the power consumption, the controller is to:
introduce time offsets for the ongoing operations across the multiple channels.

8. The storage device of claim 1, wherein, to perform the incoming operation, the controller is to:
determine that the available power, for the storage device, is sufficient for performing the incoming operation after adjusting the power consumption; and
perform the incoming operation based on determining that the available power is sufficient.

9. A method comprising:
determining a power consumption, of a storage device, for ongoing operations on the storage device;
determining that an available power, for the storage device, is insufficient for performing an incoming operation based on the power consumption;
adjusting the power consumption based on determining that the available power is insufficient for performing the incoming operation; and
performing the incoming operation based on adjusting the power consumption for the ongoing operations.

10. The method of claim 9, comprising:
determining a power deficit associated with performing the incoming operation; and
determining that the available power is insufficient for performing the incoming operation based on the power deficit.

11. The method of claim 9, comprising:
determining that the available power is insufficient for performing the incoming operation after adjusting the power consumption; and
continuing adjusting the power consumption based on determining that the available power is insufficient for performing the incoming operation after adjusting the power consumption.

12. The method of claim 9, wherein adjust the power consumption comprises one or more of:
introducing time offsets for the ongoing operations across multiple channels of the storage device;
reducing a power supply to the storage device;
enabling an option to reduce a performance of one or more of the ongoing operations to reduce a power consumption of the one or more ongoing operations; or
reducing a speed of an ongoing read operation to reduce a power consumption of the ongoing read operation.

13. The method of claim 9, comprising:
determining that the available power, for the storage device, is sufficient for performing the incoming operation after adjusting the power consumption; and
performing the incoming operation based on determining that the available power is sufficient.

14. The method of claim 9, comprising:
determining the incoming operation is associated with a quality of service (QOS) target of the storage device; and
adjusting the power consumption to enable the incoming operation to be performed based on determining in the incoming operation.

15. A non-transitory computer-readable medium storing a set of instructions, the set of instructions comprising:
one or more instructions that, when executed by one or more processors of a controller, cause the controller to:
determine a power consumption, of a storage device, for ongoing operations on the storage device;
determine that an available power, for the storage device, is insufficient for performing an incoming operation based on the power consumption;
adjust the power consumption based on determining that the available power is insufficient for performing the incoming operation; and
perform the incoming operation based on adjusting the power consumption for the ongoing operations.

16. The non-transitory computer-readable medium of claim 15, comprising:
determine a power deficit associated with performing the incoming operation; and
determine that the available power is insufficient for performing the incoming operation based on the power deficit.

17. The non-transitory computer-readable medium of claim 15, comprising:
determine that the available power is insufficient for performing the incoming operation after adjusting the power consumption; and
continue adjusting the power consumption based on determining that the available power is insufficient for performing the incoming operation after adjusting the power consumption.

18. The non-transitory computer-readable medium of claim 15, wherein the one or more instructions, that cause the controller to adjust the power consumption, cause the controller to:
introduce time offsets for the ongoing operations across multiple channels of the storage device;
reduce a power supply to the storage device;
enable an option to reduce a performance of one or more of the ongoing operations to reduce a power consumption of the one or more ongoing operations; or
reduce a speed of an ongoing read operation to reduce a power consumption of the ongoing read operation.

19. The non-transitory computer-readable medium of claim 15, comprising:
determine that the available power, for the storage device, is sufficient for performing the incoming operation after adjusting the power consumption; and
perform the incoming operation based on determining that the available power is sufficient.

20. The non-transitory computer-readable medium of claim 15, comprising:
determine the incoming operation is associated with a quality of service (QOS) target of the storage device; and
adjust the power consumption to enable the incoming operation to be performed based on determining in the incoming operation.
